(19) United States
(12) Patent Application Publication
(10) Pub. No.: US 2014/0292959 A1
(43) Pub. Date: Oct. 2, 2014

(54) Water-Based Ink for Ink-Jet Recording and Ink Cartridge

(71) Applicants: Yuki Okumura, Ichinomiya-shi (JP); Hideji Fukaya, Nagoya-shi (JP)

(72) Inventors: Yuki Okumura, Ichinomiya-shi (JP); Hideji Fukaya, Nagoya-shi (JP)

(73) Assignee: BROTHER KOGYO KABUSHIKI KAISHA, Nagoya-shi (JP)

(21) Appl. No.: 14/221,391

(22) Filed: Mar. 21, 2014

(30) Foreign Application Priority Data
Mar. 28, 2013 (JP) 2013-068043

(51) Int. Cl. C09D 11/00; B41J 2/175

(52) U.S. Cl. CPC C09D 11/324; B41J 2/17503
USPC 347/86; 106/31.6

(57) ABSTRACT

There is provided a water-based ink for ink-jet recording, including: a self-dispersible pigment; water; at least one compound A selected from the group consisting of a compound represented by a general formula (A1), a compound represented by a chemical formula (A2), and a compound represented by a general formula (A3); and at least one compound B selected from the group consisting of a compound represented by a general formula (B1), a compound represented by a chemical formula (B2), and a compound represented by a general formula (B3).

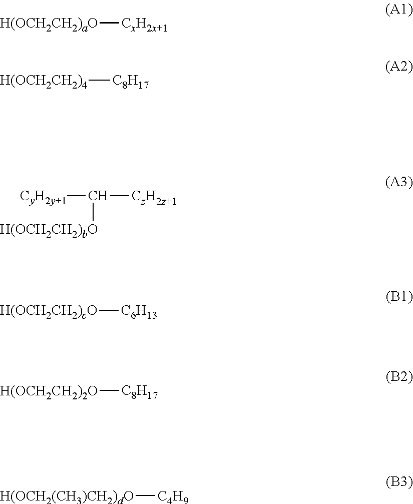

### CROSS REFERENCE TO RELATED APPLICATION

The present application claims priority from Japanese Patent Application No. 2013-068043 filed on Mar. 28, 2013 the disclosure of which is incorporated herein by reference in its entirety.

### BACKGROUND OF THE INVENTION

1. Field of the Invention

The present invention relates to a water-based ink for ink-jet recording and an ink cartridge.

2. Description of the Related Art

There has been suggested use of a surfactant in order to suppress white-striped or white-streaked unevenness (banding), which may be generated when a water-based ink for ink-jet recording using a pigment (hereinafter sometimes referred to as “water-based pigment ink”) is used in recording (Japanese Patent Application Laid-open No. 2012-246435 corresponding to United States Patent Application Publication No. US 2012/0306964).

However, even when the surfactant is used, there is still a fear, for example, that the white-striped unevenness (banding) is not suppressed satisfactorily, when ink-jet recording is executed at low resolution. In such a case, it is considered that the banding is suppressed by increasing an amount of liquid droplets at the time of the ink-jet recording. However, the increase of amount of the liquid droplets to be discharged on a recording medium deteriorates a quick drying property and thus is unsuitable for a high-speed printing. Because of the circumstances as described above, there has been desired a water-based pigment ink which is less likely to cause the white-striped unevenness (banding) as compared with conventional inks.

In view of the above, an object of the present teaching is to provide a water-based ink for ink-jet recording using a pigment which is even less likely to cause white-striped or white-streaked unevenness (banding).

### SUMMARY OF THE INVENTION

According to a first aspect of the present teaching, there is provided a water-based ink for ink-jet recording, including: a self-dispersible pigment; water; at least one compound A selected from the group consisting of a compound represented by a general formula (A1), a compound represented by a chemical formula (A2), and a compound represented by a general formula (A3); and at least one compound B selected from the group consisting of a compound represented by a general formula (B1), a compound represented by a chemical formula (B2), and a compound represented by a general formula (B3);

H(OCH₂CH₂)ₐO—CₓH₂ₓ₊₁ (A1)

in the general formula (A1), a is an integer of 6 to 9, and x is an integer of 9 to 11;

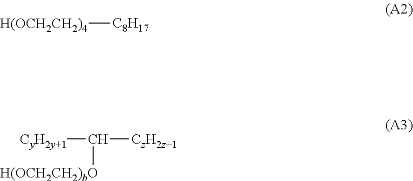

in the general formula (A3), b is an integer of 7 to 10, y and z are integers satisfying y≧1, z≧1, and y+z=8 to 13 and may be same or different from each other;

H(OCH₂CH₂)_{c}O—C₆H₁₃ (B1)

in the general formula (B1), c is 1 or 2;

H(OCH₂CH₂)₂O—C₈H₁₇ (B2)

H(OCH₂(CH₃)CH₂)_{d}O—C₄H₉ (B3)

in the general formula (B3), d is an integer of 1 to 3.

According to a second aspect of the present teaching, there is provided an ink cartridge containing the water-based ink for ink-jet recording as defined in the first aspect.

### BRIEF DESCRIPTION OF THE DRAWINGS

FIG. 1 is a schematic perspective view of exemplary construction of an ink-jet recording apparatus of the present teaching.

### DESCRIPTION OF THE PREFERRED EMBODIMENTS

An explanation will be given about a water-based ink of the present teaching. The water-based ink of the present teaching includes a self-dispersible pigment and water.

In the present teaching, the self-dispersible pigment is dispersible in water without using any dispersing agent, owing to the fact that at least one of hydrophilic functional group and the salt thereof including, for example, carbonyl group, hydroxyl group, carboxylic acid group, sulfonic acid group, and phosphoric acid group, is introduced into pigment particles by the chemical bond directly or with any group intervening therebetween. The self-dispersible pigment is preferably a self-dispersible pigment modified by carboxylic acid group (hereinafter referred to as “carboxylic acid group-modified self-dispersible pigment”). It is possible to use self-dispersible pigments subjected to the surface treatment by any one of methods described, for example, in Japanese Patent Application Laid-open No. 8-3498 (corresponding to U.S. Pat. No. 5,609,671), Published Japanese Translation of PCT International Publication for Patent Application No. 2000-513396 (corresponding to U.S. Pat. No. 5,837,045), Published Japanese Translation of PCT International Publication for Patent Application No. 2008-524400 (corresponding to United States Patent Application Publication No. US 2006/0201380), and Published Japanese Translation of PCT International Publication for Patent Application No. 2009-515007 (United States Patent Application Publication Nos. US 2007/0100023 and US 2007/0100024). It is possible to use, as a material for the self-dispersible pigment, either one of the inorganic pigment and the organic pigment. Further, a pigment suitable for the above-described treatment includes, for example, carbon black such as “MA8” and “MA100” produced by Mitsubishi Chemical Corporation. As the self-dispersible pigment, it is possible to use a commercially available product. The commercially available product includes “CAB-O-JET (trade name) 200”, “CAB-O-JET (trade name) 250C”, “CAB-O-JET (trade name) 260M”, “CAB-O-JET (trade name) 270Y”, “CAB-O-JET (trade name) 300”, “CAB-O-JET (trade name) 400”, “CAB-O-JET (trade name) 450C”, “CAB-O-JET (trade name) 465M” and “CAB-O-JET (trade name) 470Y” produced by Cabot Corporation; “BONJET (trade name) BLACK CW-1”, “BONJET (trade name) BLACK CW-2”, and “BONJET (trade name) BLACK CW-3” produced by Orient Chemical Industries, Ltd.; “LIOJET (trade name) WD BLACK 002C” produced by TOYO INK SC HOLDINGS CO., LTD.; and the like.

The solid content blending amount of the self-dispersible pigment (pigment solid content) with respect to the entire amount of the water-based ink is not particularly limited, and may be appropriately determined based on desired optical density or color (hue, tint), etc. The pigment solid content is, for example, 0.1% by weight to 20% by weight, is preferably 1% by weight to 15% by weight, and is more preferably 2% by weight to 10% by weight.

The water-based ink may include a colorant other than the above self-dispersible pigment. The colorant other than the self-dispersible pigment is exemplified, for example, by a dye and a pigment other than the self-dispersible pigment. The water-based ink may not include any colorant other than the pigment. The white-striped unevenness (banding) is more likely to occur in a recorded image when the pigment is used as the colorant. Therefore, the present teaching is effective for a water-based ink which substantially includes only the pigment as the colorant, for example, a water-based ink in which the pigment is contained in an amount of 90% by weight to 100% by weight with respect to the total amount of the colorant contained in the water-based ink. The white-striped unevenness (banding) is particularly likely to occur in a recorded image when the self-dispersible pigment modified by the carboxylic acid group is used as the colorant. Therefore, the present teaching is effective for a water-based ink which substantially includes only the self-dispersible pigment modified by the carboxylic acid group as the colorant.

The water is preferably ion-exchanged water or pure water (purified water). The blending amount of water (water ratio) with respect to the entire amount of the water-based ink is, for example, 10% by weight to 90% by weight, and is preferably 40% by weight to 80% by weight. The water ratio may be, for example, the balance of the ink, excluding other components.

The water-based ink further contains a compound A and a compound B. By using the compound A and the compound B in combination in the water-based pigment ink, it is possible to obtain a water-based ink for ink-jet recording which is less likely to cause the white-striped unevenness (banding).

For example, a commercially available product can be used as the compound A. The commercially available product of a compound represented by a general formula (A1) is exemplified by “LAOL (trade name) XA-60-50” produced by Lion Corporation; “NONION (trade name) ID-206” “NONION (trade name) ID-209” which are produced by NOF CORPORATION; and the like. The commercially available product of a compound represented by a chemical formula (A2) is exemplified by “NONION (trade name) EH-204” produced by NOF CORPORATION, and the like. The commercially available product of a compound represented by a general formula (A3) is exemplified by “TERGITOL (trade name) TMN-10” produced by The Dow Chemical Company; “SOFTANOL (trade name) 70” “SOFTANOL (trade name) 90” which are produced by NIPPON SHOKUBAI CO., LTD.; and the like. Among them, it is preferable to use a compound in which a=6 and X=9 to 11 in the general formula (A1) (for example, “LAOL (trade name) XA-60-50”) and a compound in which b=10, y≧1, z≧1, y+z=11 to 13 in the general formula (A3) (for example, “TERGITOL (trade name) TMN-10”). One kind of the compound A as described above may be used singly, or two or more kinds of the compounds A as described above may be used in combination.

The blending amount of the compound A with respect to the total amount of the water-based ink is, for example, 0.01% by weight to 5% by weight, preferably 0.1% by weight to 2% by weight, and more preferably 0.3% by weight to 1.1% by weight.

Regarding the compound B, a compound which is represented by a general formula (B1) is exemplified, for example, by diethylene glycol-n-hexyl ether and ethylene glycol-n-hexyl ether. A compound represented by a chemical formula (B2) is exemplified, for example, by diethylene glycol-2-ethylhexyl ether. A compound represented by a general formula (B3) is exemplified, for example, by tripropylene glycol-n-butyl ether, dipropylene glycol-n-butyl ether, and propylene glycol-n-butyl ether. One kind of the compound B as described above may be used singly, or two or more kinds of the compounds B as described above may be used in combination. By using the compound A and the compound B in combination in the water-based pigment ink, it is possible to suppress the white-striped unevenness (banding).

The blending amount of the compound B with respect to the total amount of the water-based ink is, for example, 0.01% by weight to 10% by weight, preferably 0.1% by weight to 5% by weight, and more preferably 0.2% by weight to 0.9% by weight.

A lower limit of the total blending amount of the compound A and the compound B with respect to the entire amount of the water-based ink is preferably not less than 0.02% by weight from the viewpoint of solid printing on the recording medium by the ink. Further, an upper limit of the total blending amount of the compound A and the compound B with respect to the entire amount of the water-based ink is preferably not more than 15% by weight from the viewpoint of compatibility between the compound A and the compound B. The total blending amount is more preferably 0.2% by weight to 7% by weight, and further preferably 0.5% by weight to 2% by weight. A weight ratio (A:B) of the compound A (A) to the compound B (B) is preferably in a range of 1:0.2 to 1:1.4. The water-based ink of the present teaching easily spreads over the recording medium by combining the compound A and the compound B, and thus the white-striped unevenness (banding) is suppressed. The reason thereof is assumed that a balance between a hydrophilic property and a hydrophobic property in the entirety of compound A and the compound B is suitable for spreading the ink over the recording medium. Then, in a case that the weight ratio (A:B) of the compound A (A) to the compound B (B) is within the above specific range, it is assumed that the balance between the hydrophilic property and the hydrophobic property in the entirety of the compound A and the compound B is more suitable for spreading the ink over the recording medium and thus the white-striped unevenness (banding) is suppressed.

The compound A is preferably at least one of the compound represented by the general formula (A1) and the compound represented by the chemical formula (A2); and the compound B is preferably at least one of the compound represented by the general formula (B1) and the compound represented by the chemical formula (B2). The compound A is preferably the compound represented by the general formula (A1) in which a=6 and X=9 to 11; and the compound B is preferably at least one selected from the group consisting of diethylene glycol-n-hexyl ether, ethylene glycol-n-hexyl ether, and diethylene glycol-2-ethylhexyl ether.

The compound A is preferably at least one of the compound represented by the general formula (A1) and the compound represented by the chemical formula (A2); and the compound B is preferably the compound represented by the general formula (B3). The compound A is preferably the compound represented by the general formula (A1) in which a=6 and X=9 to 11; and the compound B is preferably at least one selected from the group consisting of tripropylene glycol-n-butyl ether, dipropylene glycol-n-butyl ether, and propylene glycol-n-butyl ether.

The compound A is preferably the compound represented by the general formula (A3); and the compound B is preferably at least one of the compound represented by the general formula (B1) and the compound represented by the chemical formula (B2). The compound A is preferably the compound represented by the general formula (A3) in which b=10, y≧1, z≧1, and y+z=11 to 13; and the compound B is preferably at least one selected from the group consisting of diethylene glycol-n-hexyl ether, ethylene glycol-n-hexyl ether, and diethylene glycol-2-ethylhexyl ether.

The compound A is preferably the compound represented by the general formula (A3); and the compound B is preferably the compound represented by the general formula (B3). The compound A is preferably the compound represented by the general formula (A3) in which b=10, y≧1, z≧1, and y+z=11 to 13; and the compound B is preferably at least one selected from the group consisting of tripropylene glycol-n-butyl ether, dipropylene glycol-n-butyl ether, and propylene glycol-n-butyl ether.

The compound A preferably includes both the compound represented by the general formula (A1) in which a=6 and x=9 to 11 and the compound represented by the chemical formula (A2); and the compound B is preferably any one of the compound represented by the general formula (B1) and the compound represented by the general formula (B3).

The compound A is preferably any one of the compound represented by the general formula (A1) in which a=6 and x=9 to 11 and the compound represented by the general formula (A3) in which b=10, y≧1, z≧1, and y+z=11 to 13; and the compound B preferably includes both the compound represented by the general formula (B1) and the compound represented by the chemical formula (B2).

The compound A preferably includes both the compound represented by the general formula (A1) and the compound represented by the general formula (A3) in which b=10, y≧1, z≧1, and y+z=11 to 13; and the compound B is preferably any one of the compound represented by the general formula (B1) and the compound represented by the general formula (B3).

The compound A is preferably any one of the compound represented by the general formula (A1) and the compound represented by the general formula (A3) in which b=10, y≧1, z≧1, and y+z=11 to 13; and the compound B preferably includes both the compound represented by the general formula (B1) and the compound represented by the general formula (B3).

The water-based ink may further contain a humectant. The humectant is not specifically limited, which includes, for example, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyether such as polyalkylene glycol; polyhydric alcohols such as alkylene glycol, glycerol, and trimethylolpropane; 2-pyrrolidone; N-methyl-2-pyrrolidone; and 1,3-dimethyl-2-imidazolidinone. The polyalkylene glycol includes, for example, polyethylene glycol and polypropylene glycol. The alkylene glycol includes, for example, ethylene glycol, propylene glycol, diethylene glycol, triethylene glycol, dipropylene glycol, tripropylene glycol, thiodiglycol, and hexylene glycol. One type (kind) of the humectant as described above may be used singly, or two or more types (kinds) of the humectants as described above may be used in combination. Among them, it is preferable to use polyhydric alcohol such as alkylene glycol and glycerol.

The blending amount of the humectant with respect to the total amount of the water-based ink is, for example, 0% by weight to 95% by weight, preferably 5% by weight to 80% by weight, and more preferably 5% by weight to 50% by weight.

The water-based ink of the present teaching may contain a surfactant except for the compound A and a penetrant except for the compound B, provided that the effect of the present teaching can be exhibited; or it is allowable that the water-based ink does not contain any surfactant except for the compound A and any penetrant except for the compound B. Noted that both the compound A and the compound B are glycol ether, and it is allowable that the water-based ink of the present teaching does not substantially contain glycol ether other than the compound A and the compound B; or the water-based ink of the present teaching may contain glycol ether other than the compound A and the compound B within a range in which the effect of the present teaching is not deteriorated. For example, the total blending amount of the compound A and the compound B with respect to the entire blending amount of glycol ether contained in the water-based ink of the present teaching is preferably 10% by weight to 100% by weight, and is more preferably 40% by weight to 100% by weight.

The water-based ink may further contain conventionally known additives, if necessary. The additive includes, for example, pH-adjusting agents, viscosity-adjusting agents, surface tension-adjusting agents, and fungicides. The viscosity-adjusting agent is exemplified, for example, by polyvinyl alcohol, cellulose, and water-soluble resin.

The water-based ink can be prepared, for example, as follows. That is, the pigment, water, the compound A, the compound B, and other additive component(s) as necessary are mixed uniformly in accordance with any conventionally known method, and then undissolved matters are removed by a filter or the like.

As described above, according to the present teaching, it is possible to obtain the water-based ink for ink-jet recording which is less likely to cause the white-striped unevenness (banding) by using the compound A and the compound B in combination in the water-based pigment ink.

Next, an explanation will be given about an ink cartridge of the present teaching. The ink cartridge of the present teaching is an ink cartridge containing a water-based ink for ink-jet recording, wherein the water-based ink is the water-based ink for ink-jet recording of the present teaching. For example, any conventionally known main body (body) of an ink cartridge can be used for the main body of the ink cartridge of the present teaching.

Next, an explanation will be made about an ink-jet recording apparatus and an ink-jet recording method of the present teaching.

The ink-jet recording apparatus of the present teaching is an ink-jet recording apparatus including an ink accommodating section and an ink discharging mechanism which discharges an ink accommodated in the ink accommodating section, wherein the water-based ink for ink-jet recording of the present teaching is accommodated in the ink accommodating section.

The ink-jet recording method of the present teaching is an ink-jet recording method for performing recording by discharging a water-based ink on a recording medium in an ink-jet system, wherein the water-based ink for ink-jet recording of the present teaching is used as the water-based ink.

The ink-jet recording method of the present teaching can be performed by using, for example, the ink-jet recording apparatus of the present teaching. The recording includes printing of letters (text), printing of images, printing, etc.

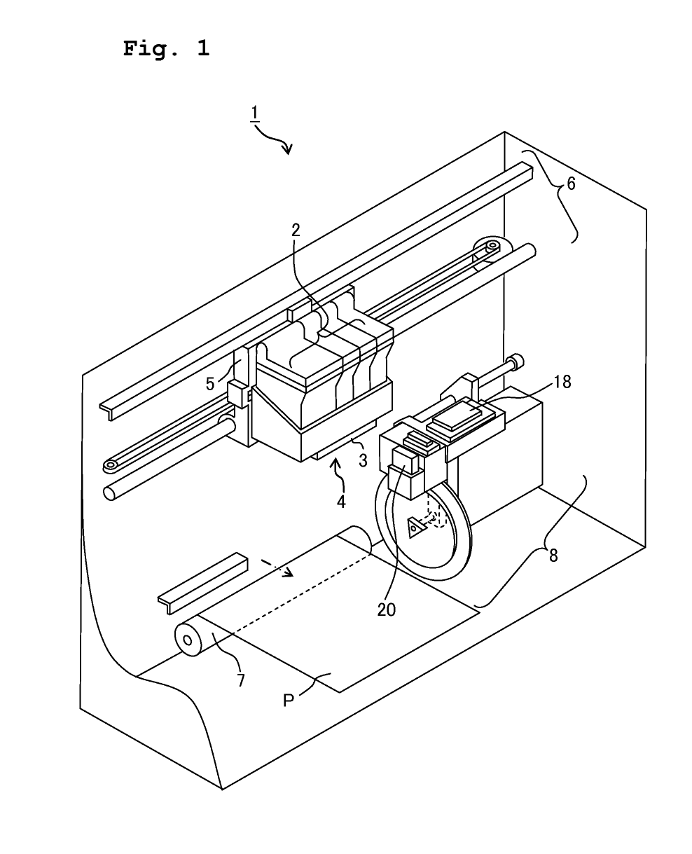

FIG. 1 shows an exemplary construction of the ink-jet recording apparatus of the present teaching. As shown in FIG. 1, an ink-jet recording apparatus 1 includes, as main constitutive elements, four ink cartridges 2, an ink discharging mechanism (ink-jet head) 3, a head unit 4, a carriage 5, a driving unit 6, a platen roller 7, and a purge unit 8.

Each of the four ink cartridges 2 includes one of four color water-based inks of yellow, magenta, cyan, and black one by one. For example, the water-based black ink is the water-based ink for ink-jet recording of the present teaching. General water-based inks may be used for the water-based inks other than the water-based black ink. The ink-jet head 3, which is installed on the head unit 4, performs recording on a recording medium P (for example, recording paper sheet). The four ink cartridges 2 and the head unit 4 are carried on the carriage 5. The driving unit 6 reciprocatively moves the carriage 5 in a linear direction. For example, a conventionally known driving unit can be used as the driving unit 6 (see, for example, Japanese Patent Application Laid-open No. 2008-246821 corresponding to United States Patent Application Publication No. US 2008/0241398). The platen roller 7 extends in the reciprocating direction of the carriage 5, and the platen roller 7 is arranged to face or to be opposite to the ink-jet head 3.

The purge unit 8 sucks any defective ink containing bubbles or the like remaining at the inside of the ink-jet head 3. For example, a conventionally known purge unit can be used as the purge unit 8 (see, for example, Japanese Patent Application Laid-open No. 2008-246821 corresponding to United States Patent Application Publication No. US 2008/0241398).

A wiper member 20 is arranged adjacently to the purge unit 8 at a portion of the purge unit 8 on a side of the platen roller 7. The wiper member 20 is formed to have a spatula-shaped form. The wiper member 20 wipes a nozzle-formed surface of the ink-jet head 3 in accordance with the movement of the carriage 5. With reference to FIG. 1, a cap 18 covers a plurality of nozzles of the ink-jet head 3, which is returned to the reset position when the recording is completed, in order to prevent the water-based inks from being dried.

In the ink-jet recording apparatus 1 of this embodiment, the four ink cartridges 2 are carried on one carriage 5 together with the head unit 4. However, the present teaching is not limited to this. In the ink-jet recording apparatus described above, the respective four ink cartridges 2 may be carried on any carriage distinctly from the head unit 4. Alternatively, the respective four ink cartridges 2 may be arranged and fixed in the ink-jet recording apparatus without being carried on the carriage 5. In the modes as described above, for example, the respective four ink cartridges 2 are connected to the head unit 4 carried on the carriage 5 by tubes or the like, and each of the water-based inks is supplied from one of the four ink cartridges 2 to the head unit 4.

The ink-jet recording, which uses the ink-jet recording apparatus 1, is carried out, for example, as follows. At first, a recording paper sheet P is supplied from a paper-feeding cassette (not shown) provided in the ink-jet recording apparatus 1 on a side portion or lower portion thereof. The recording paper sheet P is introduced between the ink-jet head 3 and the platen roller 7. A predetermined recording is performed on the introduced recording paper sheet P with the water-based ink(s) discharged from the ink-jet head 3. The recording paper sheet P for which the recording has been performed is discharged from the ink-jet recording apparatus 1. In a recorded matter recorded by the water-based ink of the present teaching, the white-striped unevenness (banding) is suppressed. In FIG. 1, illustrations of the paper-feeding mechanism and paper-discharging mechanism for the recording paper sheet P are omitted.

The apparatus shown in FIG. 1 adopts the serial type ink-jet head. However, the present teaching is not limited to this. The ink-jet recording apparatus may be an apparatus which adopts a line type ink-jet head.

### EXAMPLES

Next, Examples and Comparative Examples of the present teaching will be explained. Note that the present teaching is not limited to and is not restricted by Examples and Comparative Examples which will be described below.

### Examples 1-1 to 5-6 and Comparative Examples 1-1 to 4-15

Components except for a self-dispersible pigment which were included in the Water-based Ink Composition (Tables 1 to 9) were mixed uniformly or homogeneously; and thus an ink solvent was obtained. Subsequently, the ink solvent was added to each of the self-dispersible pigment water dispersions, followed by being mixed uniformly. After that, the obtained mixtures were each filtrated through a cellulose acetate membrane filter (pore size 3.00 μm) produced by Toyo Roshi Kaisha, Ltd., and thus the water-based inks for ink-jet recording of Examples 1-1 to 5-6 and Comparative Examples 1-1 to 4-15 were obtained. Note that, although the water-based ink used in Comparative Example 1-14 is the same as that used in Comparative Example 2-12; the water-based ink used in Comparative Example 1-17 is the same as that used in Comparative Example 2-15; and the water-based ink used in Comparative Example 1-19 is the same as that used in Comparative Example 2-17, since Comparative Examples 1-14, 1-17, and 1-19 were used to evaluate Examples 1-1 to 1-18, in which the compound represented by the general formula (B1) or the compound represented by the chemical formula (B2) was used as the compound B and Comparative Examples 2-12, 2-15, and 2-17 were used to evaluate Examples 2-1 to 2-18, in which the compound represented by the general formula (B3) was used as the compound B, Comparative Examples 1-14, 1-17, and 1-19 and Comparative Examples 2-12, 2-15, and 2-17 are shown in Table 2 and Table 4, respectively. Although the water-based ink used in Comparative Example 1-15 is the same as that used in Comparative Example 3-13, since Comparative Example 1-15 was used to evaluate Examples 1-1 to 1-18, in which the compound represented by the general formula (A1) or the compound represented by the chemical formula (A2) was used as the compound A, and Comparative Example 3-13 was used to evaluate Examples 3-1 to 3-16, in which the compound represented by the general formula (A3) was used as the compound A, Comparative Examples 1-15 and 3-13 are shown in Table 2 and Table 6, respectively. Although the water-based ink used in Comparative Example 2-13 is the same as that used in Comparative Example 4-11, since Comparative Example 2-13 was used to evaluate Examples 2-1 to 2-18, in which the compound represented by the general formula (A1) or the compound represented by the chemical formula (A2) was used as the compound A, and Comparative Example 4-11 was used to evaluate Examples 4-1 to 4-16, in which the compound represented by the general formula (A3) was used as the compound A, Comparative Examples 2-13 and 4-11 are shown in Table 4 and Table 8, respectively. Although the water-based ink used in Comparative Example 3-12 is the same as that used in Comparative Example 4-10; the water-based ink used in Comparative Example 3-15 is the same as that used in Comparative Example 4-13; and the water-based ink used in Comparative Example 3-17 is the same as that used in Comparative Example 4-15, since Comparative Examples 3-12, 3-15, and 3-17 were used to evaluate Examples 3-1 to 3-16, in which the compound represented by the general formula (B1) or the compound represented by the chemical formula (B2) was used as the compound B and Comparative Examples 4-10, 4-13, and 4-15 were used to evaluate Examples 4-1 to 4-16, in which the compound represented by the general formula (B3) was used as the compound B, Comparative Examples 3-12, 3-15, and 3-17 and Comparative Examples 4-10, 4-13, and 4-15 are shown in Table 6 and Table 8, respectively. Although the water-based ink used in Comparative Example 1-16 is the same as those used in Comparative Examples 2-14, 3-14, and 4-12; and the water-based ink used in Comparative Example 1-18 is the same as those used in Comparative Examples 2-16, 3-16, and 4-14, since Comparative Examples 1-16 and 1-18 were used to evaluate Examples 1-1 to 1-18, Comparative Examples 2-14 and 2-16 were used to evaluate Examples 2-1 to 2-18, Comparative Examples 3-14 and 3-16 were used to evaluate Examples 3-1 to 3-16, and Comparative Examples 4-12 and 4-14 were used to evaluate Examples 4-1 to 4-16, Comparative Examples 1-16 and 1-18, Comparative Examples 2-14 and 2-16, Comparative Examples 3-14 and 3-16, and Comparative Examples 4-12 and 4-14 are shown in Table 2, Table 4, Table 6, and Table 8, respectively.

The water-based inks in Examples and Comparative Examples were used to perform an evaluation of white-striped or white-streaked unevenness (banding) in the following methods.

### <Evaluation Method for Evaluation of White-Striped Unevenness (Banding)>

An ink-jet printer-equipped digital multifunction machine DCP-J525N produced by Brother Industries, Ltd. was used to record evaluation patches on a plain paper sheet (4200 produced by Xerox Corporation) by using the water-based inks of Examples and Comparative Examples at a resolution of 600 dpi×300 dpi. The evaluation patches prepared in such a manner were observed visually and by using a ×5-magnifying glass. The white-striped unevenness (banding) was evaluated in accordance with the following evaluation criteria.

### <Evaluation Criteria for Evaluation of White-Striped Unevenness (Banding)>

AA: No white-striped unevenness (banding) was observed in the evaluation patch by the magnifying glass
A: No white-striped unevenness (banding) was observed in the evaluation patch visually
B: White-striped unevenness (banding) was observed in the evaluation patch visually

The water-based ink compositions and evaluation/measurement results of the water-based inks in Examples and Comparative Examples are shown in Table 1 to Table 9. As described above, although the water-based ink used in Comparative Example 1-14 is the same as that used in Comparative Example 2-12; the water-based ink used in Comparative Example 1-17 is the same as that used in Comparative Example 2-15; and the water-based ink used in Comparative Example 1-19 is the same as that used in Comparative Example 2-17, since Comparative Examples 1-14, 1-17, and 1-19 were used to evaluate Examples 1-1 to 1-18, in which the compound represented by the general formula (B1) or the compound represented by the chemical formula (B2) was used as the compound B and Comparative Examples 2-12, 2-15, and 2-17 were used to evaluate Examples 2-1 to 2-18, in which the compound represented by the general formula (B3) was used as the compound B, Comparative Examples 1-14, 1-17, and 1-19 and Comparative Examples 2-12, 2-15, and 2-17 are shown in Table 2 and Table 4, respectively. Although the water-based ink used in Comparative Example 1-15 is the same as that used in Comparative Example 3-13, since Comparative Example 1-15 was used to evaluate Examples 1-1 to 1-18, in which the compound represented by the general formula (A1) or the compound represented by the chemical formula (A2) was used as the compound A, and Comparative Example 3-13 was used to evaluate Examples 3-1 to 3-16, in which the compound represented by the general formula (A3) was used as the compound A, Comparative Examples 1-15 and 3-13 are shown in Table 2 and Table 6, respectively. Although the water-based ink used in Comparative Example 2-13 is the same as that used in Comparative Example 4-11, since Comparative Example 2-13 was used to evaluate Examples 2-1 to 2-18, in which the compound represented by the general formula (A1) or the compound represented by the chemical formula (A2) was used as the compound A, and Comparative Example 4-11 was used to evaluate Examples 4-1 to 4-16, in which the compound represented by the general formula (A3) was used as the compound A, Comparative Examples 2-13 and 4-11 are shown in Table 4 and Table 8, respectively. Although the water-based ink used in Comparative Example 3-12 is the same as that used in Comparative Example 4-10; the water-based ink used in Comparative Example 3-15 is the same as that used in Comparative Example 4-13; and the water-based ink used in Comparative Example 3-17 is the same as that used in Comparative Example 4-15, since Comparative Examples 3-12, 3-15, and 3-17 were used to evaluate Examples 3-1 to 3-16, in which the compound represented by the general formula (B1) or the compound represented by the chemical formula (B2) was used as the compound B and Comparative Examples 4-10, 4-13, and 4-15 were used to evaluate Examples 4-1 to 4-16, in which the compound represented by the general formula (B3) was used as the compound B, Comparative Examples 3-12, 3-15, and 3-17 and Comparative Examples 4-10, 4-13, and 4-15 are shown in Table 6 and Table 8, respectively. Although the water-based ink used in Comparative Example 1-16 is the same as those used in Comparative Examples 2-14, 3-14, and 4-12; and the water-based ink used in Comparative Example 1-18 is the same as those used in Comparative Examples 2-16, 3-16, and 4-14, since Comparative Examples 1-16 and 1-18 were used to evaluate Examples 1-1 to 1-18, Comparative Examples 2-14 and 2-16 were used to evaluate Examples 2-1 to 2-18, Comparative Examples 3-14 and 3-16 were used to evaluate Examples 3-1 to 3-16, and Comparative Examples 4-12 and 4-14 were used to evaluate Examples 4-1 to 4-16, Comparative Examples 1-16 and 1-18, Comparative Examples 2-14 and 2-16, Comparative Examples 3-14 and 3-16, and Comparative Examples 4-12 and 4-14 are shown in Table 2, Table 4, Table 6, and Table 8, respectively.

### TABLES 1-9 (FOLLOWING)

### Legend

*1: Self-dispersible pigment modified by carboxylic acid group; manufactured by Cabot Specialty Chemicals; pigment concentration: 15% by weight; number in parenthesis indicates pigment solid content amount
*2: Self-dispersible pigment modified by carboxylic acid group; manufactured by Orient Chemical Industries, Ltd.; pigment concentration: 20% by weight; number in parenthesis indicates pigment solid content amount
*3: Compound represented by general formula (A1); manufactured by Lion Corporation; active-ingredient amount: 50% by weight to 60% by weight; number in parenthesis indicates a minimum value of the active-ingredient amount
*4: Compound represented by general formula (A1); manufactured by NOF CORP
*5: Compound represented by general formula (A1); manufactured by NOF CORP
*6: Compound represented by chemical formula (A2); manufactured by NOF CORP
*7: Polyoxyethylene(8) lauryl ether, Compound represented by general formula (A1) in which a=8, x=12; manufactured by Kao Corp
*8: Polyoxyethylene(12) lauryl ether, Compound represented by general formula (A1) in which a=12, x=12; manufactured by Kao Corp
*9: Polyoxyethylene(3) isodecyl ether, Compound represented by general formula (A1) in which a=3, x=10; manufactured by NOF CORP
*10: Polyoxyethylene(8) 2-ethylhexyl ether; manufactured by NOF CORP
*11: Polyoxyethylene(4) butyl ether; manufactured by KH Neochem Co., Ltd.
*12: Compound represented by general formula (A3); manufactured by Dow Chemical Company
*13: Compound represented by general formula (A3); manufactured by NIPPON SHOKUBAI CO., LTD.
*14: Compound represented by general formula (A3); manufactured by NIPPON SHOKUBAI CO., LTD
*15: Compound represented by general formula (A3) in which b=5, y=5, z=7; manufactured by Dow Chemical Company
*16: Polyoxyethylene (m)-polyoxypropylene (n) alkyl ether, in which m+n=8.5; manufactured by NIPPON SHOKUBAI CO., LTD.
*17: Polyoxyethylene (m)-polyoxypropylene (n) alkyl ether, in which m+n=11.5; manufactured by NIPPON SHOKUBAI CO., LTD.

TABLE 1

| | | EXAMPLES | | | | | | | |
|---|---|---|---|---|---|---|---|---|---|
| | | 1-1 | 1-2 | 1-3 | 1-4 | 1-5 | 1-6 | 1-7 | 1-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | BONJET (trade name) BLACK CW-1 (*2) | — | — | — | — | — | — | — | — |
| Composition | Glycerol | 33.0 | 33.0 | 33.0 | 33.0 | 33.0 | 33.0 | 33.0 | 33.0 |
| (% by | Triethylene glycol | — | — | — | — | — | — | — | — |
| weight) | 1,2-hexanediol | — | — | — | — | — | — | — | — |
| | LAOL (trade name) XA-60-50 (*3) | 2.20 | 1.40 | 0.60 | — | — | — | — | — |
| | | (1.10) | (0.70) | (0.30) | | | | | |
| | NONION (trade name) ID-206 (*4) | — | — | — | 1.10 | 0.30 | — | — | — |
| | NONION (trade name) ID-209 (*5) | — | — | — | — | — | 1.10 | 0.70 | — |
| | NONION (trade name) EH-204 (*6) | — | — | — | — | — | — | — | 0.70 |
| | Diethylene glycol-n-hexyl ether | 0.90 | 0.50 | 0.20 | 0.90 | 0.20 | 0.90 | 0.50 | 0.50 |
| | Ethylene glycol-n-hexyl ether | — | — | — | — | — | — | — | — |
| | Diethylene glycol-2-ethylhexyl ether | — | — | — | — | — | — | — | — |
| | Water | balance | balance | balance | balance | balance | balance | balance | balance |
| White-striped unevenness (banding) | | AA | AA | AA | AA | A | AA | AA | AA |
| | | EXAMPLES | | | | | | | |
| | | 1-9 | 1-10 | 1-11 | 1-12 | 1-13 | 1-14 | 1-15 | 1-16 |
| Water- | CAB-O-JET (trade name) 300 (*1) | 46.67 | 46.67 | 46.67 | 47.67 | 46.67 | 46.67 | 46.67 | — |
| based | | (7.0) | (7.0) | (7.0) | (7.0) | (7.0) | (7.0) | (7.0) | |
| Ink | BONJET (trade name) BLACK CW-1 (*2) | — | — | — | — | — | — | — | 35.00 |
| Composition | | | | | | | | | (7.0) |
| (% by | Glycerol | 33.0 | 33.0 | 33.0 | 33.0 | 33.0 | 30.0 | 31.0 | 33.0 |
| weight) | Triethylene glycol | — | — | — | — | — | 2.0 | — | — |
| | 1,2-hexanediol | — | — | — | — | — | — | 1.0 | — |
| | LAOL (trade name) XA-60-50 (*3) | — | 2.20 | — | — | — | 2.20 | 1.40 | 1.40 |
| | | | (1.10) | | | | (1.10) | (0.70) | (0.70) |
| | NONION (trade name) ID-206 (*4) | — | — | — | — | — | — | — | — |
| | NONION (trade name) ID-209 (*5) | — | — | — | 1.10 | — | — | — | — |
| | NONION (trade name) EH-204 (*6) | 0.30 | — | 0.30 | — | 0.30 | — | — | — |
| | Diethylene glycol-n-hexyl ether | 0.20 | — | — | — | — | 0.90 | 0.40 | 0.30 |
| | Ethylene glycol-n-hexyl ether | — | 0.90 | 0.20 | — | — | — | — | — |
| | Diethylene glycol-2-ethylhexyl ether | — | — | — | 0.90 | 0.20 | — | — | — |
| | Water | balance | balance | balance | balance | balance | balance | balance | balance |

| | | | | | | | | |
|---|---|---|---|---|---|---|---|---|
| White-striped unevenness (banding) | A | AA | A | AA | A | AA | AA | AA |

| | | EXAMPLES | |
|---|---|---|---|
| | | 1-17 | 1-18 |
| Water- | CAB-O-JET (trade name) 300 (*1) | 46.67 | 46.67 |
| based | | (7.0) | (7.0) |
| Ink | BONJET (trade name) BLACK CW-1 (*2) | — | — |
| Composition | Glycerol | 33.0 | 33.0 |
| (% by | Triethylene glycol | — | — |
| weight) | 1,2-hexanediol | — | — |
| | LAOL (trade name) XA-60-50 (*3) | 1.00 | 1.00 |
| | | (0.50) | (0.50) |
| | NONION (trade name) ID-206 (*4) | — | — |
| | NONION (trade name) ID-209 (*5) | — | — |
| | NONION (trade name) EH-204 (*6) | 0.30 | — |
| | Diethylene glycol-n-hexyl ether | 0.30 | 0.20 |
| | Ethylene glycol-n-hexyl ether | — | — |
| | Diethylene glycol-2-ethylhexyl ether | — | 0.30 |
| | Water | balance | balance |

| | | |
|---|---|---|
| White-striped unevenness (banding) | AA | AA |

TABLE 2

| | | COMPARATIVE EXAMPLES | | | | | | | |
|---|---|---|---|---|---|---|---|---|---|
| | | 1-1 | 1-2 | 1-3 | 1-4 | 1-5 | 1-6 | 1-7 | 1-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 |
| Composition | LAOL (trade name) XA-60-50 (*3) | — | — | — | — | — | 2.20 | 2.20 | 2.20 |
| (% by | | | | | | | (1.10) | (1.10) | (1.10) |
| weight) | EMULGEN (trade name) 108 (*7) | 1.10 | — | — | — | — | — | — | — |
| | EMULGEN (trade name) 120 (*8) | — | 1.10 | — | — | — | — | — | — |
| | NONION (trade name) ID-203 (*9) | — | — | 1.10 | — | — | — | — | — |
| | NONION (trade name) EH-208(*10) | — | — | — | 1.10 | — | — | — | — |
| | BUTYCENOL (trade name) 40 (*11) | — | — | — | — | 1.10 | — | — | — |
| | Diethylene glycol-n-hexyl ether | 0.90 | 0.90 | 0.90 | 0.90 | 0.90 | — | — | — |
| | Triethylene glycol-n-butyl ether | — | — | — | — | — | 0.90 | — | — |
| | Diethylene glycol-n-butyl ether | — | — | — | — | — | — | 0.90 | — |
| | Ethylene glycol-n-butyl ether | — | — | — | — | — | — | — | 0.90 |
| | Triethylene glycol-n-dodecyl ether | — | — | — | — | — | — | — | — |
| | Diethylene glycol-n-dodecyl ether | — | — | — | — | — | — | — | — |
| | Ethylene glycol-n-dodecyl ether | — | — | — | — | — | — | — | — |
| | Ethylene glycol-2-ethylhexyl ether | — | — | — | — | — | — | — | — |
| | Propylene glycol-n-phenyl ether | — | — | — | — | — | — | — | — |
| | Water | balance | balance | balance | balance | balance | balance | balance | balance |
| White-striped unevenness (banding) | | B | B | B | B | B | B | B | B |
| | | COMPARATIVE EXAMPLES | | | | | | | |
| | | 1-9 | 1-10 | 1-11 | 1-12 | 1-13 | 1-14 | 1-15 | 1-16 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 |
| Composition | LAOL (trade name) XA-60-50 (*3) | 2.20 | 2.20 | 2.20 | 2.20 | 2.20 | 2.80 | — | — |
| (% by | | (1.10) | (1.10) | (1.10) | (1.10) | (1.10) | (1.40) | | |
| weight) | EMULGEN (trade name) 108 (*7) | — | — | — | — | — | — | — | — |
| | EMULGEN (trade name) 120 (*8) | — | — | — | — | — | — | — | — |
| | NONION (trade name) ID-203 (*9) | — | — | — | — | — | — | — | — |
| | NONION (trade name) EH-208(*10) | — | — | — | — | — | — | — | — |
| | BUTYCENOL (trade name) 40 (*11) | — | — | — | — | — | — | — | — |
| | Diethylene glycol-n-hexyl ether | — | — | — | — | — | — | 1.30 | — |
| | Triethylene glycol-n-butyl ether | — | — | — | — | — | — | — | — |
| | Diethylene glycol-n-butyl ether | — | — | — | — | — | — | — | — |
| | Ethylene glycol-n-butyl ether | — | — | — | — | — | — | — | — |
| | Triethylene glycol-n-dodecyl ether | 0.90 | — | — | — | — | — | — | — |
| | Diethylene glycol-n-dodecyl ether | — | 0.90 | — | — | — | — | — | — |
| | Ethylene glycol-n-dodecyl ether | — | — | 0.90 | — | — | — | — | — |
| | Ethylene glycol-2-ethylhexyl ether | — | — | — | 0.90 | — | — | — | — |
| | Propylene glycol-n-phenyl ether | — | — | — | — | 0.90 | — | — | — |
| | Water | balance | balance | balance | balance | balance | balance | balance | balance |

| | | | | | | | | |
|---|---|---|---|---|---|---|---|---|
| White-striped unevenness (banding) | B | B | B | B | B | B | B | B |

| | | COMPARATIVE EXAMPLES | | |
|---|---|---|---|---|
| | | 1-17 | 1-18 | 1-19 |
| Water- | CAB-O-JET (trade name) 300 (*1) | 46.67 | 46.67 | 46.67 |
| based | | (7.0) | (7.0) | (7.0) |
| Ink | Glycerol | 33.0 | 33.0 | 33.0 |
| Composition | LAOL (trade name) XA-60-50 (*3) | — | — | — |
| (% by | EMULGEN (trade name) 108 (*7) | 1.00 | — | 1.00 |
| weight) | EMULGEN (trade name) 120 (*8) | — | — | — |
| | NONION (trade name) ID-203 (*9) | — | — | — |
| | NONION (trade name) EH-208(*10) | — | — | — |
| | BUTYCENOL (trade name) 40 (*11) | — | — | — |
| | Diethylene glycol-n-hexyl ether | — | — | — |
| | Triethylene glycol-n-butyl ether | — | 0.80 | 0.80 |
| | Diethylene glycol-n-butyl ether | — | — | — |
| | Ethylene glycol-n-butyl ether | — | — | — |
| | Triethylene glycol-n-dodecyl ether | — | — | — |
| | Diethylene glycol-n-dodecyl ether | — | — | — |
| | Ethylene glycol-n-dodecyl ether | — | — | — |
| | Ethylene glycol-2-ethylhexyl ether | — | — | — |
| | Propylene glycol-n-phenyl ether | — | — | — |
| | Water | balance | balance | balance |

| | | | |
|---|---|---|---|
| White-striped unevenness (banding) | B | B | B |

TABLE 3

| | | EXAMPLES | | | | | | | |
|---|---|---|---|---|---|---|---|---|---|
| | | 2-1 | 2-2 | 2-3 | 2-4 | 2-5 | 2-6 | 2-7 | 2-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | BONJET (trade name) BLACK CW-1 (*2) | — | — | — | — | — | — | — | — |
| Composition | Glycerol | 33.0 | 33.0 | 33.0 | 33.0 | 33.0 | 33.0 | 33.0 | 33.0 |
| (% by | Triethylene glycol | — | — | — | — | — | — | — | — |
| weight) | 1,2-hexanediol | — | — | — | — | — | — | — | — |
| | LAOL (trade name) XA-60-50 (*3) | 2.20 | 1.40 | 0.80 | — | — | — | — | — |
| | | (1.10) | (0.70) | (0.40) | | | | | |
| | NONION (trade name) ID-206 (*4) | — | — | — | 1.10 | 0.40 | — | — | — |
| | NONION (trade name) ID-209 (*5) | — | — | — | — | — | 1.10 | 0.70 | — |
| | NONION (trade name) EH-204 (*6) | — | — | — | — | — | — | | 0.70 |
| | Tripropylene glycol-n-butyl ether | 0.80 | 0.50 | 0.20 | 0.80 | 0.20 | 0.80 | 0.50 | 0.50 |
| | Dipropylene glycol-n-butyl ether | — | — | — | — | — | — | — | — |
| | Propylene glycol-n-butyl ether | — | — | — | — | — | — | — | — |
| | Water | balance | balance | balance | balance | balance | balance | balance | balance |
| White-striped unevenness (banding) | | AA | AA | AA | AA | A | AA | A | A |
| | | EXAMPLES | | | | | | | |
| | | 2-9 | 2-10 | 2-11 | 2-12 | 2-13 | 2-14 | 2-15 | 2-16 |
| Water- | CAB-O-JET (trade name) 300 (*1) | 46.67 | 46.67 | 46.67 | 47.67 | 46.67 | 46.67 | 46.67 | — |
| based | | (7.0) | (7.0) | (7.0) | (7.0) | (7.0) | (7.0) | (7.0) | |
| Ink | BONJET (trade name) BLACK CW-1 (*2) | — | — | — | — | — | — | — | 35.00 |
| Composition | | | | | | | | | (7.0) |
| (% by | Glycerol | 33.0 | 33.0 | 33.0 | 33.0 | 33.0 | 30.0 | 31.0 | 33.0 |
| weight) | Triethylene glycol | — | — | — | — | — | 2.0 | — | — |
| | 1,2-hexanediol | — | — | — | — | — | — | 1.0 | — |
| | LAOL (trade name) XA-60-50 (*3) | — | — | — | 1.40 | — | 2.20 | 1.40 | 1.40 |
| | | | | | (0.70) | | (1.10) | (0.70) | (0.70) |
| | NONION (trade name) ID-206 (*4) | — | — | — | — | — | — | — | — |
| | NONION (trade name) ID-209 (*5) | — | 1.10 | — | — | — | — | — | — |
| | NONION (trade name) EH-204 (*6) | 0.40 | — | 0.40 | — | 0.40 | — | — | — |
| | Tripropylene glycol-n-butyl ether | 0.20 | — | — | — | — | 0.80 | 0.40 | 0.40 |
| | Dipropylene glycol-n-butyl ether | — | 0.80 | 0.20 | — | — | — | — | — |
| | Propylene glycol-n-butyl ether | — | — | — | 0.50 | 0.20 | — | — | — |
| | Water | balance | balance | balance | balance | balance | balance | balance | balance |

| | | | | | | | | |
|---|---|---|---|---|---|---|---|---|
| White-striped unevenness (banding) | A | AA | A | AA | A | AA | AA | AA |

| | | EXAMPLES | |
|---|---|---|---|
| | | 2-17 | 2-18 |
| Water- | CAB-O-JET (trade name) 300 (*1) | 46.67 | 46.67 |
| based | | (7.0) | (7.0) |
| Ink | BONJET (trade name) BLACK CW-1 (*2) | — | — |
| Composition | Glycerol | 33.0 | 33.0 |
| (% by | Triethylene glycol | — | — |
| weight) | 1,2-hexanediol | — | — |
| | LAOL (trade name) XA-60-50 (*3) | 1.00 | 1.00 |
| | | (0.50) | (0.50) |
| | NONION (trade name) ID-206 (*4) | — | — |
| | NONION (trade name) ID-209 (*5) | — | — |
| | NONION (trade name) EH-204 (*6) | 0.40 | — |
| | Tripropylene glycol-n-butyl ether | 0.30 | 0.20 |
| | Dipropylene glycol-n-butyl ether | — | 0.20 |
| | Propylene glycol-n-butyl ether | — | — |
| | Water | balance | balance |

| | | |
|---|---|---|
| White-striped unevenness (banding) | AA | AA |

TABLE 4

| | | COMPARATIVE EXAMPLES | | | | | | | |
|---|---|---|---|---|---|---|---|---|---|
| | | 2-1 | 2-2 | 2-3 | 2-4 | 2-5 | 2-6 | 2-7 | 2-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 |
| Composition | LAOL (trade name) XA-60-50 (*3) | — | — | — | — | — | 2.20 | 2.20 | 2.20 |
| (% by | | | | | | | (1.10) | (1.10) | (1.10) |
| weight) | EMULGEN (trade name) 108 (*7) | 1.10 | — | — | — | — | — | — | — |
| | EMULGEN (trade name) 120 (*8) | — | 1.10 | — | — | — | — | — | — |
| | NONION (trade name) ID-203 (*9) | — | — | 1.10 | — | — | — | — | — |
| | NONION (trade name) EH-208(*10) | — | — | — | 1.10 | — | — | — | — |
| | BUTYCENOL (trade name) 40 (*11) | — | — | — | — | 1.10 | — | — | — |
| | Tripropylene glycol-n-butyl ether | 0.80 | 0.80 | 0.80 | 0.80 | 0.80 | — | — | — |
| | Triethylene glycol-n-butyl ether | — | — | — | — | — | 0.80 | — | — |
| | Diethylene glycol-n-butyl ether | — | — | — | — | — | — | 0.80 | — |
| | Ethylene glycol-n-butyl ether | — | — | — | — | — | — | — | 0.80 |
| | Dipropylene glycol-n-propyl ether | — | — | — | — | — | — | — | — |
| | Propylene glycol-n-propyl ether | — | — | — | — | — | — | — | — |
| | Propylene glycol-n-phenyl ether | — | — | — | — | — | — | — | — |
| | Water | balance | balance | balance | balance | balance | balance | balance | balance |

| | | | | | | | | |
|---|---|---|---|---|---|---|---|---|
| White-striped unevenness (banding) | B | B | B | B | B | B | B | B |

| | | COMPARATIVE EXAMPLES | | | | | | | | |
|---|---|---|---|---|---|---|---|---|---|---|
| | | 2-9 | 2-10 | 2-11 | 2-12 | 2-13 | 2-14 | 2-15 | 2-16 | 2-17 |
| Water- | CAB-O-JET (trade name) 300 (*1) | 46.67 | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 | 33.0 |
| Composition | LAOL (trade name) XA-60-50 (*3) | 2.20 | 2.20 | 2.20 | 2.80 | — | — | — | — | — |
| (% by | | (1.10) | (1.10) | (1.10) | (1.40) | | | | | |
| weight) | EMULGEN (trade name) 108 (*7) | — | — | — | — | — | — | 1.00 | — | 1.00 |
| | EMULGEN (trade name) 120 (*8) | — | — | — | — | — | — | — | — | — |
| | NONION (trade name) ID-203 (*9) | — | — | — | — | — | — | — | — | — |
| | NONION (trade name) EH-208(*10) | — | — | — | — | — | — | — | — | — |
| | BUTYCENOL (trade name) 40 (*11) | — | — | — | — | — | — | — | — | — |
| | Tripropylene glycol-n-butyl ether | — | — | — | — | 1.30 | — | — | — | — |
| | Triethylene glycol-n-butyl ether | — | — | — | — | — | — | — | 0.80 | 0.80 |
| | Diethylene glycol-n-butyl ether | — | — | — | — | — | — | — | — | — |
| | Ethylene glycol-n-butyl ether | — | — | — | — | — | — | — | — | — |
| | Dipropylene glycol-n-propyl ether | 0.80 | — | — | — | — | — | — | — | — |
| | Propylene glycol-n-propyl ether | — | 0.80 | — | — | — | — | — | — | — |
| | Propylene glycol-n-phenyl ether | — | — | 0.80 | — | — | — | — | — | — |
| | Water | balance | balance | balance | balance | balance | balance | balance | balance | balance |

| | | | | | | | | | |
|---|---|---|---|---|---|---|---|---|---|
| White-striped unevenness (banding) | B | B | B | B | B | B | B | B | B |

TABLE 5

| | | EXAMPLES | | | | | | | |
|---|---|---|---|---|---|---|---|---|---|
| | | 3-1 | 3-2 | 3-3 | 3-4 | 3-5 | 3-6 | 3-7 | 3-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | BONJET (trade name) BLACK CW-1 (*2) | — | — | — | — | — | — | — | — |
| Composition | Glycerol | 33.0 | 33.0 | 33.0 | 33.0 | 33.0 | 33.0 | 33.0 | 33.0 |
| (% by | Triethylene glycol | — | — | — | — | — | — | — | — |
| weight) | 1,2-hexanediol | — | — | — | — | — | — | — | — |
| | TERGITOL (trade name) TMN-10 (*12) | 1.00 | 0.50 | 0.30 | — | — | — | — | 1.00 |
| | SOFTANOL (trade name) 70 (*13) | — | — | — | 1.00 | 0.50 | — | — | — |
| | SOFTANOL (trade name) 90 (*14) | — | — | — | — | — | 0.50 | 0.30 | — |
| | Diethylene glycol-n-hexyl ether | 0.80 | 0.40 | 0.20 | 0.80 | 0.40 | 0.40 | 0.20 | — |
| | Ethylene glycol-n-hexyl ether | — | — | — | — | — | — | — | 0.80 |
| | Diethylene glycol-2-ethylhexyl ether | — | — | — | — | — | — | — | — |
| | Water | balance | balance | balance | balance | balance | balance | balance | balance |
| White-striped unevenness (banding) | | AA | AA | AA | AA | A | A | A | AA |
| | | EXAMPLES | | | | | | | |
| | | 3-9 | 3-10 | 3-11 | 3-12 | 3-13 | 3-14 | 3-15 | 3-16 |
| Water- | CAB-O-JET (trade name) 300 (*1) | 46.67 | 46.67 | 46.67 | 46.67 | 46.67 | — | 46.67 | 46.67 |
| based | | (7.0) | (7.0) | (7.0) | (7.0) | (7.0) | | (7.0) | (7.0) |
| Ink | BONJET (trade name) BLACK CW-1 (*2) | — | — | — | — | — | 35.00 | — | — |
| Composition | | | | | | | (7.0) | | |
| (% by | Glycerol | 33.0 | 33.0 | 33.0 | 30.0 | 31.0 | 33.0 | 33.0 | 33.0 |
| weight) | Triethylene glycol | — | — | — | 2.0 | — | — | — | — |
| | 1,2-hexanediol | — | — | — | — | 1.0 | — | — | — |
| | TERGITOL (trade name) TMN-10 (*12) | — | 0.50 | — | 1.00 | 0.50 | 1.00 | 0.50 | 0.50 |
| | SOFTANOL (trade name) 70 (*13) | 0.50 | — | 0.30 | — | — | — | — | — |
| | SOFTANOL (trade name) 90 (*14) | — | — | — | — | — | — | 0.30 | — |
| | Diethylene glycol-n-hexyl ether | — | — | — | 0.80 | 0.40 | 0.80 | 0.20 | 0.20 |
| | Ethylene glycol-n-hexyl ether | 0.40 | — | 0.20 | — | — | — | — | — |
| | Diethylene glycol-2-ethylhexyl ether | — | 0.40 | — | — | — | — | — | 0.20 |
| | Water | balance | balance | balance | balance | balance | balance | balance | balance |

| | | | | | | | | |
|---|---|---|---|---|---|---|---|---|
| White-striped unevenness (banding) | A | AA | A | AA | AA | AA | AA | AA |

TABLE 6

| | | COMPARATIVE EXAMPLES | | | | | | | |
|---|---|---|---|---|---|---|---|---|---|
| | | 3-1 | 3-2 | 3-3 | 3-4 | 3-5 | 3-6 | 3-7 | 3-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 |
| Composition | TERGITOL (trade name) TMN-10 (*12) | — | — | — | 1.00 | 1.00 | 1.00 | 1.00 | 1.00 |
| (% by | TERGITOL (trade name) TMN-15-S-5 | 1.00 | — | — | — | — | — | — | — |
| weight) | (*15) | | | | | | | | |
| | SOFTANOL (trade name) EP5035 (*16) | — | 1.00 | — | — | — | — | — | — |
| | SOFTANOL (trade name) EP7035 (*17) | — | — | 1.00 | — | — | — | — | — |
| | Diethylene glycol-n-hexyl ether | 0.80 | 0.80 | 0.80 | — | — | — | — | — |
| | Triethylene glycol-n-butyl ether | — | — | — | 0.80 | — | — | — | — |
| | Diethylene glycol-n-butyl ether | — | — | — | — | 0.80 | — | — | — |
| | Ethylene glycol-n-butyl ether | — | — | — | — | — | 0.80 | — | — |
| | Triethylene glycol-n-dodecyl ether | — | — | — | — | — | — | 0.80 | — |
| | Diethylene glycol-n-dodecyl ether | — | — | — | — | — | — | — | 0.80 |
| | Ethylene glycol-n-dodecyl ether | — | — | — | — | — | — | — | — |
| | Ethylene glycol-2-ethylhexyl ether | — | — | — | — | — | — | — | — |
| | Propylene glycol-n-phenyl ether | — | — | — | — | — | — | — | — |
| | Water | balance | balance | balance | balance | balance | balance | balance | balance |

| | | | | | | | | |
|---|---|---|---|---|---|---|---|---|
| White-striped unevenness (banding) | B | B | B | B | B | B | B | B |

| | | COMPARATIVE EXAMPLES | | | | | | | | |
|---|---|---|---|---|---|---|---|---|---|---|
| | | 3-9 | 3-10 | 3-11 | 3-12 | 3-13 | 3-14 | 3-15 | 3-16 | 3-17 |
| Water- | CAB-O-JET (trade name) 300 (*1) | 46.67 | 47.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 | 33.0 |
| Composition | TERGITOL (trade name) TMN-10 | 1.00 | 2.20 | 2.20 | 1.40 | — | — | — | — | — |
| (% by | (*12) | | | | | | | | | |
| weight) | TERGITOL (trade name) | — | — | — | — | — | — | 1.00 | — | 1.00 |
| | TMN-15-S-5 (*15) | | | | | | | | | |
| | SOFTANOL (trade name) EP5035 | — | — | — | — | — | — | — | — | — |
| | (*16) | | | | | | | | | |
| | SOFTANOL (trade name) EP7035 | — | — | — | — | — | — | — | — | — |
| | (*17) | | | | | | | | | |
| | Diethylene glycol-n-hexyl ether | — | — | — | — | 1.30 | — | — | — | — |
| | Triethylene glycol-n-butyl ether | — | — | — | — | — | — | — | 0.80 | 0.80 |
| | Diethylene glycol-n-butyl ether | — | — | — | — | — | — | — | — | — |
| | Ethylene glycol-n-butyl ether | — | — | — | — | — | — | — | — | — |
| | Triethylene glycol-n-dodecyl ether | — | — | — | — | — | — | — | — | — |
| | Diethylene glycol-n-dodecyl ether | — | — | — | — | — | — | — | — | — |
| | Ethylene glycol-n-dodecyl ether | 0.80 | — | — | — | — | — | — | — | — |
| | Ethylene glycol-2-ethylhexyl ether | — | 0.80 | — | — | — | — | — | — | — |
| | Propylene glycol-n-phenyl ether | — | — | 0.80 | — | — | — | — | — | — |
| | Water | balance | balance | balance | balance | balance | balance | balance | balance | balance |

| | | | | | | | | | |
|---|---|---|---|---|---|---|---|---|---|
| White-striped unevenness (banding) | B | B | B | B | B | B | B | B | B |

TABLE 7

| | | EXAMPLES | | | | | | | |
|---|---|---|---|---|---|---|---|---|---|
| | | 4-1 | 4-2 | 4-3 | 4-4 | 4-5 | 4-6 | 4-7 | 4-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | BONJET (trade name) BLACK CW-1 (*2) | — | — | — | — | — | — | — | — |
| Composition | Glycerol | 33.0 | 33.0 | 33.0 | 33.0 | 33.0 | 33.0 | 33.0 | 33.0 |
| (% by | Triethylene glycol | — | — | — | — | — | — | — | — |
| weight) | 1,2-hexanediol | — | — | — | — | — | — | — | — |
| | TERGITOL (trade name) TMN-10 (*12) | 1.00 | 0.60 | 0.40 | — | — | — | — | 0.60 |
| | SOFTANOL (trade name) 70 (*13) | — | — | — | 1.00 | 0.60 | — | — | — |
| | SOFTANOL (trade name) 90 (*14) | — | — | — | — | — | 0.60 | 0.40 | — |
| | Tripropylene glycol-n-butyl ether | 0.70 | 0.40 | 0.20 | 0.70 | 0.40 | 0.40 | 0.20 | — |
| | Dipropylene glycol-n-butyl ether | — | — | — | — | — | — | — | 0.40 |
| | Propylene glycol-n-butyl ether | — | — | — | — | — | — | — | — |
| | Water | balance | balance | balance | balance | balance | balance | balance | balance |
| White-striped unevenness (banding) | | AA | AA | AA | AA | A | A | A | AA |
| | | EXAMPLES | | | | | | | |
| | | 4-9 | 4-10 | 4-11 | 4-12 | 4-13 | 4-14 | 4-15 | 4-16 |
| Water- | CAB-O-JET (trade name) 300 (*1) | 46.67 | 46.67 | 46.67 | 46.67 | 46.67 | — | 46.67 | 46.67 |
| based | | (7.0) | (7.0) | (7.0) | (7.0) | (7.0) | | (7.0) | (7.0) |
| Ink | BONJET (trade name) BLACK CW-1 (*2) | — | — | — | — | — | 35.00 | — | — |
| Composition | | | | | | | (7.0) | | |
| (% by | Glycerol | 33.0 | 33.0 | 33.0 | 30.0 | 31.0 | 33.0 | 33.0 | 33.0 |
| weight) | Triethylene glycol | — | — | — | 2.0 | — | — | — | — |
| | 1,2-hexanediol | — | — | — | — | 1.0 | — | — | — |
| | TERGITOL (trade name) TMN-10 (*12) | — | 1.00 | — | 1.00 | 0.60 | 1.00 | 0.60 | 0.60 |
| | SOFTANOL (trade name) 70 (*13) | 0.40 | — | — | — | — | — | — | — |
| | SOFTANOL (trade name) 90 (*14) | — | — | 0.40 | — | — | — | 0.30 | — |
| | Tripropylene glycol-n-butyl ether | — | — | — | 0.70 | 0.40 | 0.70 | 0.20 | 0.20 |
| | Dipropylene glycol-n-butyl ether | 0.20 | — | — | — | — | — | — | 0.20 |
| | Propylene glycol-n-butyl ether | — | 0.70 | 0.20 | — | — | — | — | — |
| | Water | balance | balance | balance | balance | balance | balance | balance | balance |

| | | | | | | | | |
|---|---|---|---|---|---|---|---|---|
| White-striped unevenness (banding) | A | AA | A | AA | AA | AA | AA | AA |

TABLE 8

| | | COMPARATIVE EXAMPLES | | | | | | | |
|---|---|---|---|---|---|---|---|---|---|
| | | 4-1 | 4-2 | 4-3 | 4-4 | 4-5 | 4-6 | 4-7 | 4-8 |
| Water- | CAB-O-JET (trade name) 300 (*1) | 46.67 | 46.67 | 46.67 | 46.67 | 46.67 | 46.67 | 46.67 | 46.67 |
| based | | (7.0) | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 | 33.0 |
| Composition | TERGITOL (trade name) TMN-10 (*12) | — | — | — | 1.00 | 1.00 | 1.00 | 1.00 | 1.00 |
| (% by | TERGITOL (trade name) TMN-15-S-5 | 1.00 | — | — | — | — | — | — | — |
| weight) | (*15) | | | | | | | | |
| | SOFTANOL (trade name) EP5035 (*16) | — | 1.00 | — | — | — | — | — | — |
| | SOFTANOL (trade name) EP7035 (*17) | — | — | 1.00 | — | — | — | — | — |
| | Tripropylene glycol-n-butyl ether | 0.70 | 0.70 | 0.70 | — | — | — | — | — |
| | Triethylene glycol-n-butyl ether | — | — | — | 0.70 | — | — | — | — |
| | Diethylene glycol-n-butyl ether | — | — | — | — | 0.70 | — | — | — |
| | Ethylene glycol-n-butyl ether | — | — | — | — | — | 0.70 | — | — |
| | Dipropylene glycol-n-propyl ether | — | — | — | — | — | — | 0.70 | — |
| | Propylene glycol-n-propyl ether | — | — | — | — | — | — | — | 0.70 |
| | Propylene glycol-n-phenyl ether | — | — | — | — | — | — | — | — |
| | Water | balance | balance | balance | balance | balance | balance | balance | balance |

| | | | | | | | | |
|---|---|---|---|---|---|---|---|---|
| White-striped unevenness (banding) | B | B | B | B | B | B | B | B |

| | | COMPARATIVE EXAMPLES | | | | | | |
|---|---|---|---|---|---|---|---|---|
| | | 4-9 | 4-10 | 4-11 | 4-12 | 4-13 | 4-14 | 4-15 |
| Water- | CAB-O-JET (trade name) 300 (*1) | 46.67 | 46.67 | 46.67 | 46.67 | 46.67 | 46.67 | 46.67 |
| based | | (7.0) | (7.0) | (7.0) | (7.0) | (7.0) | (7.0) | (7.0) |
| Ink | Glycerol | 33.0 | 33.0 | 33.0 | 33.0 | 33.0 | 33.0 | 33.0 |
| Composition | TERGITOL (trade name) TMN-10 (*12) | 1.00 | 1.40 | — | — | — | — | — |
| (% by | TERGITOL (trade name) TMN-15-S-5 | — | — | — | — | 1.00 | — | 1.00 |
| weight) | (*15) | | | | | | | |
| | SOFTANOL (trade name) EP5035 (*16) | — | — | — | — | — | — | — |
| | SOFTANOL (trade name) EP7035 (*17) | — | — | — | — | — | — | — |
| | Tripropylene glycol-n-butyl ether | — | — | 1.30 | — | — | — | — |
| | Triethylene glycol-n-butyl ether | — | — | — | — | — | 0.80 | 0.80 |
| | Diethylene glycol-n-butyl ether | — | — | — | — | — | — | — |
| | Ethylene glycol-n-butyl ether | — | — | — | — | — | — | — |
| | Dipropylene glycol-n-propyl ether | — | — | — | — | — | — | — |
| | Propylene glycol-n-propyl ether | — | — | — | — | — | — | — |
| | Propylene glycol-n-phenyl ether | 0.70 | — | — | — | — | — | — |
| | Water | balance | balance | balance | balance | balance | balance | balance |

| | | | | | | | |
|---|---|---|---|---|---|---|---|
| White-striped unevenness (banding) | B | B | B | B | B | B | B |

TABLE 9

| | | EXAMPLES | | | | | |
|---|---|---|---|---|---|---|---|
| | | 5-1 | 5-2 | 5-3 | 5-4 | 5-5 | 5-6 |
| Water- | CAB-O-JET (trade name) 300 (*1) | 46.67 | 46.67 | 46.67 | 46.67 | 46.67 | 46.67 |
| based | | (7.0) | (7.0) | (7.0) | (7.0) | (7.0) | (7.0) |
| Ink | Glycerol | 33.0 | 33.0 | 33.0 | 33.0 | 33.0 | 33.0 |
| Composition | LAOL (trade name) XA-60-50 (*3) | 1.00 | — | 1.00 | — | — | 1.40 |
| (% by | | (0.50) | | (0.50) | | | (0.70) |
| weight) | NONION (trade name) ID-206 (*4) | — | 0.30 | — | 1.10 | — | — |
| | NONION (trade name) EH-204 (*6) | — | — | 0.30 | — | — | — |
| | TERGITOL (trade name) TMN-10 (*12) | 0.50 | 0.50 | — | — | 0.50 | — |
| | SOFTANOL (trade name) 90 (*14) | — | — | — | — | — | — |
| | Diethylene glycol-n-hexyl ether | — | — | 0.30 | 0.50 | 0.50 | 0.50 |
| | Ethylene glycol-n-hexyl ether | 0.20 | — | — | — | — | — |
| | Diethylene glycol-2-ethylhexyl ether | — | — | — | — | — | 0.20 |
| | Tripropylene glycol-n-butyl ether | — | — | — | — | 0.20 | — |
| | Propylene glycol-n-butyl ether | — | 0.30 | — | 0.20 | — | — |
| | Water | balance | balance | balance | balance | balance | balance |

| | | | | | | |
|---|---|---|---|---|---|---|
| White-striped unevenness (banding) | AA | AA | AA | AA | AA | AA |

As shown in TABLE 1, the result of evaluation of the white-striped unevenness (banding) was superior in each of Examples 1-1 to 1-18, in which the compound represented by the general formula (A1) or the compound represented by the chemical formula (A2) was used as the compound A and the compound represented by the general formula (B1) or the compound represented by the chemical formula (B2) was used as the compound B. Meanwhile, as shown in TABLE 2, the result of evaluation of the white-striped unevenness (banding) was inferior in each of Comparative Examples 1-1 to 1-5 in which the surfactant similar to the compound A was used instead of the compound A; each of Comparative Examples 1-6 to 1-13 in which glycol ether similar to the compound B was used instead of the compound B; Comparative Example 1-14 in which the compound B was not used; Comparative Example 1-15 in which the compound A was not used; Comparative Example 1-16 in which neither the compound A nor the compound B was used; Comparative Example 1-17 in which the surfactant similar to the compound A was used instead of the compound A and the compound B was not used; Comparative Example 1-18 in which the compound A was not used and glycol ether similar to the compound B was used instead of the compound B; and Comparative Example 1-19 in which the surfactant similar to compound A was used instead of the compound A and glycol ether similar to the compound B was used instead of the compound B.

As shown in TABLE 3, the result of evaluation of the white-striped unevenness (banding) was superior in each of Examples 2-1 to 2-18, in which the compound represented by the general formula (A1) or the compound represented by the chemical formula (A2) was used as the compound A and the compound represented by the general formula (B3) was used as the compound B. Meanwhile, as shown in TABLE 4, the result of evaluation of the white-striped unevenness (banding) was inferior in each of Comparative Examples 2-1 to 2-5 in which the surfactant similar to the compound A was used instead of the compound A; each of Comparative Examples 2-6 to 2-11 in which glycol ether similar to the compound B was used instead of the compound B; Comparative Example 2-12 in which the compound B was not used; Comparative Example 2-13 in which the compound A was not used; Comparative Example 2-14 in which neither the compound A nor the compound B was used; Comparative Example 2-15 in which the surfactant similar to the compound A was used instead of the compound A and the compound B was not used; Comparative Example 2-16 in which the compound A was not used and glycol ether similar to the compound B was used instead of the compound B; and Comparative Example 2-17 in which the surfactant similar to compound A was used instead of the compound A and glycol ether similar to the compound B was used instead of the compound B.

As shown in TABLE 5, the result of evaluation of the white-striped unevenness (banding) was superior in each of Examples 3-1 to 3-16, in which the compound represented by the general formula (A3) was used as the compound A and the compound represented by the general formula (B1) or the compound represented by the chemical formula (B2) was used as the compound B. Meanwhile, as shown in TABLE 6, the result of evaluation of the white-striped unevenness (banding) was inferior in each of Comparative Examples 3-1 to 3-3 in which the surfactant similar to the compound A was used instead of the compound A; each of Comparative Examples 3-4 to 3-11 in which glycol ether similar to the compound B was used instead of the compound B; Comparative Example 3-12 in which the compound B was not used; Comparative Example 3-13 in which the compound A was not used; Comparative Example 3-14 in which neither the compound A nor the compound B was used; Comparative Example 3-15 in which the surfactant similar to the compound A was used instead of the compound A and the compound B was not used; Comparative Example 3-16 in which the compound A was not used and glycol ether similar to the compound B was used instead of the compound B; and Comparative Example 3-17 in which the surfactant similar to compound A was used instead of the compound A and glycol ether similar to the compound B was used instead of the compound B.

As shown in TABLE 7, the result of evaluation of the white-striped unevenness (banding) was superior in each of Examples 4-1 to 4-16, in which the compound represented by the general formula (A3) was used as the compound A and the compound represented by the general formula (B3) was used as the compound B. Meanwhile, as shown in TABLE 8, the result of evaluation of the white-striped unevenness (banding) was inferior in each of Comparative Examples 4-1 to 4-3 in which the surfactant similar to the compound A was used instead of the compound A; each of Comparative Examples 4-4 to 4-9 in which glycol ether similar to the compound B was used instead of the compound B; Comparative Example 4-10 in which the compound B was not used; Comparative Example 4-11 in which the compound A was not used; Comparative Example 4-12 in which neither the compound A nor the compound B was used; Comparative Example 4-13 in which the surfactant similar to the compound A was used instead of the compound A and the compound B was not used; Comparative Example 4-14 in which the compound A was not used and glycol ether similar to the compound B was used instead of the compound B; and Comparative Example 4-15 in which the surfactant similar to compound A was used instead of the compound A and glycol ether similar to the compound B was used instead of the compound B.

As shown in TABLE 9, the result of evaluation of the white-striped unevenness (banding) was superior in each of Examples 5-1 and 5-2 in which the compound represented by the general formula (A1) and the compound represented by the general formula (A3) were used in combination as the compound A; Example 5-3 in which the compound represented by the general formula (A1) and the compound represented by the chemical formula (A2) were used in combination as the compound A; each of Examples 5-4 and 5-5 in which the compound represented by the general formula (B1) and the compound represented by the general formula (B3) were used in combination as the compound B; and Example 5-6 in which the compound represented by the general formula (B1) and the compound represented by the chemical formula (B2) were used in combination as the compound B.

As described above, the water-based ink of the present teaching is less likely to cause the white-striped unevenness (banding). The usage of the water-based ink of the present teaching is not particularly limited and is widely applicable to a variety of kinds of ink-jet recording.

What is claimed is:

1. A water-based ink for ink-jet recording, comprising:
a self-dispersible pigment;
water;
at least one compound A selected from the group consisting of a compound represented by a general formula (A1), a compound represented by a chemical formula (A2), and a compound represented by a general formula (A3); and
at least one compound B selected from the group consisting of a compound represented by a general formula (B1), a compound represented by a chemical formula (B2), and a compound represented by a general formula (B3);
H(OCH₂CH₂)ₐO—CₓH₂ₓ₊₁ (A1)
in the general formula (A1), a is an integer of 6 to 9, and x is an integer of 9 to 11; 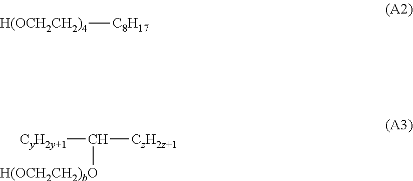
in the general formula (A3), b is an integer of 7 to 10, y and z are integers satisfying y≧1, z≧1, and y+z=8 to 13 and are same or different from each other;
H(OCH₂CH₂)_{c}O—C₆H₁₃ (B1)
in the general formula (B1), c is 1 or 2;
H(OCH₂CH₂)₂O—C₈H₁₇ (B2)
H(OCH₂(CH₃)CH₂)_{d}O—C₄H₉ (B3)
in the general formula (B3), d is an integer of 1 to 3.

2. The water-based ink for ink-jet recording according to claim 1, wherein the compound A is at least one of a compound represented by the general formula (A1) in which a=6 and x=9 to 11 and a compound represented by the general formula (A3) in which b=10, y≧1, z≧1, and y+z=11 to 13.

3. The water-based ink for ink-jet recording according to claim 1,
wherein the compound represented by the general formula (B1) is at least one of diethylene glycol-n-hexyl ether and ethylene glycol-n-hexyl ether;
the compound represented by the chemical formula (B2) is diethylene glycol-2-ethylhexyl ether; and
the compound represented by the general formula (B3) is at least one selected from the group consisting of tripropylene glycol-n-butyl ether, dipropylene glycol-n-butyl ether, and propylene glycol-n-butyl ether.

4. The water-based ink for ink-jet recording according to claim 1,
wherein the compound A is at least one of the compound represented by the general formula (A1) and the compound represented by the chemical formula (A2); and
the compound B is at least one of the compound represented by the general formula (B1) and the compound represented by the chemical formula (B2).

5. The water-based ink for ink-jet recording according to claim 1,
wherein the compound A is a compound represented by the general formula (A1) in which a=6 and x=9 to 11; and
the compound B is at least one selected from the group consisting of diethylene glycol-n-hexyl ether, ethylene glycol-n-hexyl ether, and diethylene glycol-2-ethylhexyl ether.

6. The water-based ink for ink-jet recording according to claim 1,
wherein the compound A is at least one of the compound represented by the general formula (A1) and the compound represented by the chemical formula (A2); and
the compound B is the compound represented by the general formula (B3).

7. The water-based ink for ink-jet recording according to claim 1,
wherein the compound A is a compound represented by the general formula (A1) in which a=6 and x=9 to 11; and
the compound B is at least one selected from the group consisting of tripropylene glycol-n-butyl ether, dipropylene glycol-n-butyl ether, and propylene glycol-n-butyl ether.

8. The water-based ink for ink-jet recording according to claim 1,
wherein the compound A is the compound represented by the general formula (A3); and
the compound B is at least one of the compound represented by the general formula (B1) and the compound represented by the chemical formula (B2).

9. The water-based ink for ink-jet recording according to claim 1,
wherein the compound A is a compound represented by the general formula (A3) in which b=10, y≧1, z≧1, and y+z=11 to 13; and
the compound B is at least one selected from the group consisting of diethylene glycol-n-hexyl ether, ethylene glycol-n-hexyl ether, and diethylene glycol-2-ethylhexyl ether.

10. The water-based ink for ink-jet recording according to claim 1,
wherein the compound A is the compound represented by the general formula (A3); and
the compound B is the compound represented by the general formula (B3).

11. The water-based ink for ink-jet recording according to claim 1,
wherein the compound A is a compound represented by the general formula (A3) in which b=10, y≧1, z≧1, and y+z=11 to 13; and
the compound B is at least one selected from the group consisting of tripropylene glycol-n-butyl ether, dipropylene glycol-n-butyl ether, and propylene glycol-n-butyl ether.

12. The water-based ink for ink-jet recording according to claim 1,
wherein the compound A includes a compound represented by the general formula (A1) in which a=6 and x=9 to 11 and the compound represented by the chemical formula (A2); and
the compound B is the compound represented by the general formula (B1) or the compound represented by the general formula (B3).

13. The water-based ink for ink-jet recording according to claim 1,
wherein the compound A is a compound represented by the general formula (A1) in which a=6 and x=9 to 11 or a compound represented by the general formula (A3) in which b=10, y≧1, z≧1, and y+z=11 to 13; and
the compound B includes the compound represented by the general formula (B1) and the compound represented by the chemical formula (B2).

14. The water-based ink for ink-jet recording according to claim 1,
wherein the compound A includes the compound represented by the general formula (A1) and a compound represented by the general formula (A3) in which b=10, y≧1, z≧1, and y+z=11 to 13; and
the compound B is the compound represented by the general formula (B1) or the compound represented by the general formula (B3).

15. The water-based ink for ink-jet recording according to claim 1,
wherein the compound A is the compound represented by the general formula (A1) or a compound represented by the general formula (A3) in which b=10, y≧1, z≧1, and y+z=11 to 13; and
the compound B includes the compound represented by the general formula (B1) and the compound represented by the general formula (B3).

16. The water-based ink for ink-jet recording according to claim 1,
wherein the compound A is contained in the water-based ink in an amount of 0.1% by weight to 2% by weight and the compound B is contained in the water-based ink in an amount of 0.1% by weight to 5% by weight.

17. The water-based ink for ink-jet recording according to claim 1,
wherein a total amount of the compound A and the compound B in the water-based ink is 0.2% by weight to 7% by weight.

18. The water-based ink for ink-jet recording according to claim 1,
wherein a weight ratio (A:B) of the compound A (A) to the compound B (B) in the water-based ink is in a range of 1:0.2 to 1:1.4.

19. The water-based ink for ink-jet recording according to claim 1, wherein the self-dispersible pigment is a self-dispersible pigment modified by carboxylic acid group.

20. The water-based ink for ink-jet recording according to claim 1, wherein a total blending amount of the compound A and the compound B with respect to an entire blending amount of glycol ether contained in the water-based ink is 10% by weight to 100% by weight.

21. An ink cartridge containing the water-based ink for ink-jet recording as defined in claim 1.
